(19) United States
(12) Patent Application Publication
(10) Pub. No.: US 2016/0168721 A1
(43) Pub. Date: Jun. 16, 2016

(54) COLD SPRAY NOZZLE ASSEMBLY

(71) Applicant: UNITED TECHNOLOGIES CORPORATION, FARMINGTON, CT (US)

(72) Inventors: Aaron T. Nardi, East Granby, CT (US); Michael A. Klecka, Vernon, CT (US); Victor K. Champagne, Dudley, MA (US)

(21) Appl. No.: 14/890,570

(22) PCT Filed: Jan. 15, 2014
(86) PCT No.: PCT/US2014/011581

§ 371 Date: Nov. 11, 2015

Related U.S. Application Data
(60) Provisional application No. 61/822,649, filed on May 13, 2013.

(51) Int. Cl. C23C 24/04; B05B 7/14

(52) U.S. Cl. CPC C23C 24/04; B05B 7/1486

(57) ABSTRACT

A cold spray nozzle assembly is disclosed that includes a nozzle body formed from a first material and an adapter body formed from a second material wherein each body has a passage the communicates with one another along an axis. The nozzle body is formed from a polymeric material and the adapter body formed from a metallic material.

### CROSS REFERENCE TO RELATED APPLICATIONS

This application claims the benefit of and priority to U.S. Provisional Application No. 61/822,649 filed on May 13, 2013, the entire contents of which are hereby incorporated by reference in their entirety.

### BACKGROUND OF THE INVENTION

1. Field of the Invention

The subject invention relates to improvements in nozzles for cold spray deposition, and more particularly, to a cold spray nozzle with components manufactured from dissimilar materials.

2. Description of Related Art

Cold gas dynamic spraying (e.g. cold spray) involves depositing powdered metal on a workpiece through solid state bonding. This bonding mechanism is achieved through acceleration of the powder particles (typically metal, but occasionally polymer or ceramic and metal composites) to supersonic speeds through a nozzle with a converging/diverging passage using helium and/or nitrogen gas as a conveyor.

Nozzles used in cold spray systems have been manufactured from materials including brass, stainless steel, tool steel, tungsten carbide, and to a limited extent ceramics and polymers. During deposition of certain materials, namely aluminum and aluminum alloys, titanium and titanium alloys, and some nickel alloys, the nozzle tends to foul or clog with the powder, causing system failure and requiring work to remove the damaged nozzle. In some instances, fouling of aluminum occurs within a matter of 3-4 minutes, whereas a minimum of eight (8) hours of continuous operation is often desired in commercial applications.

An improved cold spray nozzle demonstrating less fouling and a more desirable level of continuous operation is disclosed in commonly assigned U.S. Pat. No. 1,543,764 to Haynes et al. This nozzle has a converging section and a diverging section and is monolithically formed from a very hard polymer known as polybenzimidazole, which is available commercially under the trade name Celazole. Polybenzimidazole is stable up to 800 degrees Fahrenheit (427° C.), and has a Rockwell E hardness of 105 and excellent erosion resistance properties.

While the monolithically formed polymeric nozzle disclosed by Haynes et al. provides certain advantages over prior art metallic nozzles, the diverging/converging passage running through the nozzle is difficult to machine in an efficient manner. It would be beneficial therefore, to provide a more easily manufactured nozzle that incorporates the functional advantages of a polymeric cold spray nozzle.

### SUMMARY OF THE INVENTION

The subject invention is directed to a new and useful spray nozzle assembly for use in cold spray systems for depositing metal alloy coatings on workpieces. The nozzle assembly includes a nozzle body formed from a first material and an adapter body formed from a second material, wherein each body has a passage the communicates with one another along an axis.

The nozzle body is preferably formed from a polymeric material, such as for example, polybenzimidazole, or a similar material. The adapter body is preferably formed from a metallic material, such as for example, stainless steel or tool steel.

The nozzle body has a proximal engagement portion and a distally extending barrel portion. A diverging passage extends through the nozzle body from the proximal engagement portion toward a distal exit end of the barrel portion. The adapter has a proximal connector portion for mating with a fitting on a supply system and a distal engagement portion for mating with the proximal engagement portion of the nozzle body. A converging passage extends through the adapter body from the proximal connector portion to the distal engagement portion for communicating with the diverging passage of the nozzle body.

The distal engagement portion of the adapter body has a reception bore formed therein for receiving the proximal engagement portion of the nozzle body. An exterior surface of the distal engagement portion of the adapter body is threaded for receiving a compression nut configured to temporarily secure the adapter body and nozzle body to one another. In addition, a compression sleeve is provided for placement upon the nozzle body adjacent the proximal engagement portion of the nozzle body within the reception bore of the adapter body for cooperating with the compression nut.

A frusto-conical seat is formed at a proximal end of the reception bore for mating with a complementary shaped recess formed in a proximal end of the nozzle body. Preferably, the converging passage of the adapter body includes a throat section of constant diameter extending within the frusto-conical seat to accommodate for wear between the mating ends of the two nozzle components.

These and other features of the cold spray nozzle assembly of the subject invention and the manner in which it is employed will become more readily apparent to those having ordinary skill in the art from the following enabling description of the preferred embodiments of the subject invention taken in conjunction with the several drawings described below.

### BRIEF DESCRIPTION OF THE DRAWINGS

So that those skilled in the art to which the subject invention appertains will readily understand how to make and use the cold spray nozzle assembly of the subject invention without undue experimentation, preferred embodiments thereof will be described in detail herein below with reference to certain figures, wherein:

FIG. 1 is a perspective view of the cold spray nozzle assembly of the subject invention, which includes a polymeric nozzle body and a metallic adapter body;

FIG. 2 is an exploded perspective view of the cold spray nozzle assembly of FIG. 1, with parts separated for ease of illustration;

FIG. 3 is a side elevational view of the cold spray nozzle assembly shown in cross-section, and taken along line 3-3 of FIG. 1, which illustrates the geometry of the converging-diverging bore that extends through the nozzle assembly of the subject invention; and

FIG. 4 is an enlarged localized view of the throat section of the cold spray nozzle assembly shown in FIG. 3.

### DETAILED DESCRIPTION OF PREFERRED EMBODIMENTS

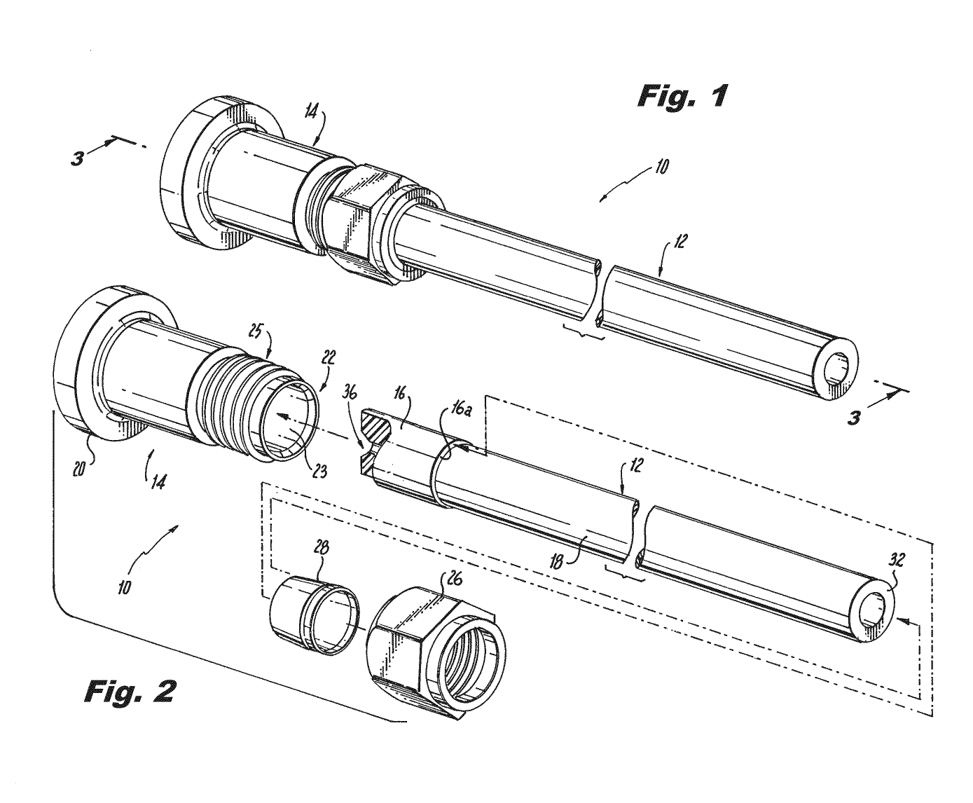

Referring now to the drawings, wherein like reference numerals identify similar structural features or aspects of the subject invention, there is illustrated in FIG. 1 an exemplary embodiment of a cold spray nozzle assembly constructed in accordance with a preferred embodiment of the subject invention and designated generally by reference numeral 10. The cold spray nozzle assembly 10 of the subject invention is particularly adapted for use in cold spray systems for depositing powdered metal alloy coatings on workpieces.

Referring to FIG. 1, the nozzle assembly 10 includes two basic component parts that are manufactured from two different materials. More particularly, the nozzle assembly 10 includes an elongated nozzle body 12 formed from a relatively hard polymeric material, such as, for example, polybenzimidazole, or a similar polymeric material. The nozzle assembly 10 further includes an adapter body 14 formed from a metallic material, such as, for example, stainless steel or tool steel.

Referring to FIG. 2, the nozzle body 12 has a proximal engagement portion 16 and a distally extending barrel portion 18. The adapter body 14 has a proximal connector portion 20 for mating with a conventional fitting on a supply system (not shown) and a distal engagement portion 22 for mechanically mating with the proximal engagement portion 16 of the nozzle body 12 in a temporary manner that will be described in more detail below.

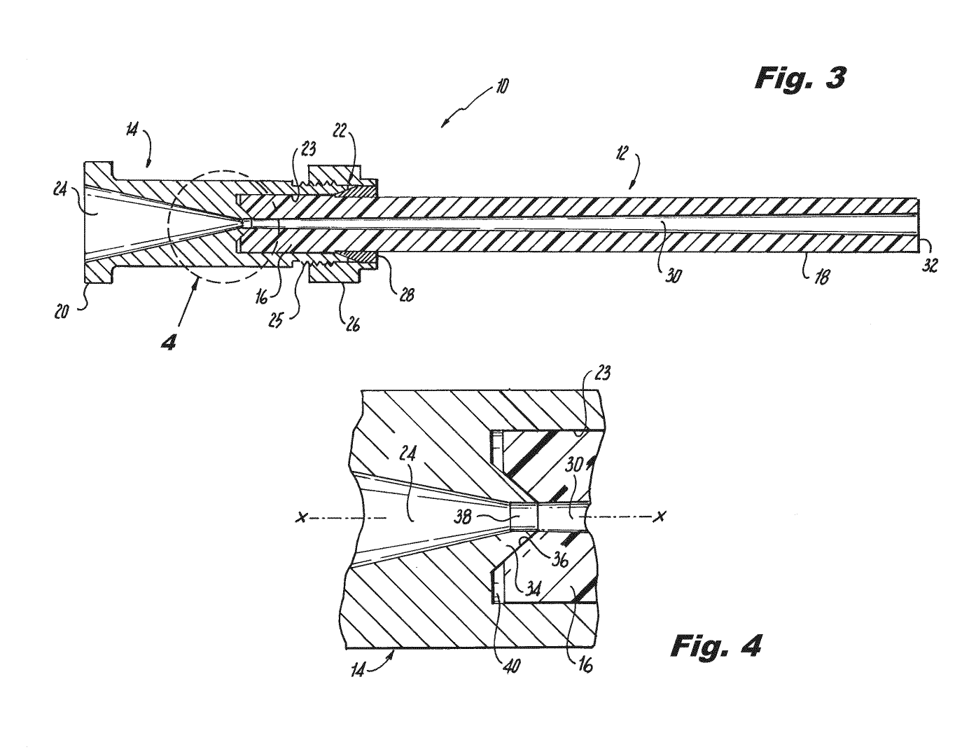

Referring to FIG. 3, a converging passage 24 is defined within the proximal connector portion 20 of the adapter body 14. The distal engagement portion 22 of the adapter body 14 has a reception bore 23 formed therein for receiving the proximal engagement portion 16 of the nozzle body 12. An exterior and generally cylindrical surface 25 of the distal engagement portion 22 of the adapter body 14 is threaded for receiving a compression nut 26. Compression nut 26 is configured to temporarily or releasably secure the adapter body 14 and nozzle body 12 to one another.

In addition, a compression sleeve 28 is provided for placement upon and around the nozzle body 12 in a location adjacent the leading edge surface 16a of the proximal engagement portion 16 of the nozzle body 12. Within the reception bore 23 of the distal engagement portion 22 of adapter body 14, the compression sleeve 28 cooperates with the compression nut 26 to temporarily or releasably secure the adapter body 14 and nozzle body 12 to one another. The compression sleeve 28 is preferably formed from a relatively soft metal, such as brass. In contrast, the compression nut 26 is preferably formed from the same metallic material as the adapter body 14.

A diverging passage 30 is defined by and communicates through the nozzle body 12 from the proximal engagement portion 16 toward a distal exit end 32 of the barrel portion 18. The two-part construction of the nozzle assembly 10 allows for efficient manufacturing of the continuously tapering passage 30 of nozzle body 12, as compared to a prior art monolithically formed polymeric nozzle body having a converging/diverging passage formed therethrough.

Referring to FIG. 4, a frusto-conical seat 34 is formed at a proximal end or bottom of the reception bore 23 of adapter body 14 for mating with a complementary shaped recesses surface 36 formed in a proximal end of the proximal engagement portion 16 of the nozzle body 12. The complementary shaped seat 34 and recessed surface 36 provide an effective seal between the two intimately engaged structures, and enables the proximal engagement portion 16 of the nozzle body 12 to be self-centering within the reception bore 23 of the distal engagement portion 22 of the adapter body 14. Those skilled in the art will readily appreciate that the alternative complementary shaped structures can be used to form the seat 34 and recessed surface 36, and thus enhance the intimate engagement between the nozzle body 12 and adapter body 14.

The converging passage 24 within adapter body 14 communicates with a throat section 38 of predetermined length and constant diameter, which extends within the frusto-conical seat 34 at the bottom of reception bore 23. The throat section 38 is located at the junction between the converging passage 24 of adapter body 14 and the diverging passage 30 of nozzle body 12. This area is most susceptible to erosion.

The throat section 38 is designed to accommodate for wear and thus increase the operational life of the nozzle body 12. More particularly, to the extent that the forward surface of the frusto-conical seat 24 experiences wear while in use, that wear and any associated movement of the proximal portion 16 of nozzle body 12 within the reception bore 23 of adapter body 14 will be accommodated or otherwise taken up by the slack gap 40 provided between the floor of the reception bore 23 and the proximal end surface of engagement portion 16.

When the nozzle assembly 10 is completely assembled the throat section 38 is located between the converging and diverging passages 24, 30. Throat section 38 and passages 24, 30 are substantially concentric with one another and communicate along a an axis X-X that may be substantially straight, as best seen in FIG. 4.

The nozzle body 12 has an overall length of about between 5 inches and 7 inches, and more preferably the length of the nozzle body 12 is about 6 inches. This is a sufficient length to enable the diverging passage 30 to accelerate the particles of powdered metal to a supersonic velocity. Furthermore, the diverging passage 30 of nozzle assembly 10 is dimensioned and configured to allow the efficient acceleration of powder particles to a velocity ranging from 300 to 1200 m/s.

Those skilled in the art will readily appreciate that because a polymeric material is only used to form the diverging section of the hybrid spray nozzle assembly 10 and not the converging section of the hybrid spray nozzle assembly 10, the typical operational temperature limitations of a polymeric material do not act to diminish the overall operational range of the hybrid nozzle assembly 10.

While the subject invention has been shown and described with reference to preferred embodiments, those skilled in the art will readily appreciate that various changes and/or modifications may be made thereto without departing from the spirit and scope of the subject invention as defined by the appended claims.

1. A cold spray nozzle assembly comprising:
a) a nozzle body formed from a first material; and
b) an adapter body formed from a second material wherein each body has a passage that communicates with one another along an axis.

2. A cold spray nozzle assembly as recited in claim 1, wherein the nozzle body is formed from a polymeric material.

3. A cold spray nozzle assembly as recited in claim 1, wherein the adapter body is formed from a metallic material.

4. A cold spray nozzle assembly as recited in claim 1, wherein the nozzle body has a proximal engagement portion and a distally extending barrel portion.

5. A cold spray nozzle assembly as recited in claim 4, wherein a diverging passage extends through the elongated nozzle body from the proximal engagement portion toward a distal end of the barrel portion.

6. A cold spray nozzle assembly as recited in claim 5, wherein the adapter body has a proximal connector portion for mating with a fitting and a distal engagement portion for mating with the proximal engagement portion of the nozzle body.

7. A cold spray nozzle assembly as recited in claim 6, wherein a converging passage extends through the adapter body from the proximal connector portion to the distal engagement portion for communicating with the diverging passage of the nozzle body.

8. A cold spray nozzle assembly as recited in claim 7, wherein the distal engagement portion of the adapter body has a reception bore formed therein for receiving the proximal engagement portion of the nozzle body.

9. A cold spray nozzle assembly as recited in claim 8, wherein a frusto-conical seat is formed at a proximal end of the reception bore for mating with a complementary shaped recess formed in a proximal end of the nozzle body.

10. A cold spray nozzle assembly as recited in claim 9, wherein an exterior surface of the distal engagement portion of the adapter body is threaded for receiving a compression nut configured to temporarily secure the adapter body and nozzle body to one another.

11. A cold spray nozzle assembly as recited in claim 10, further comprising a compression sleeve dimensioned for placement upon the nozzle body adjacent the proximal engagement portion of the nozzle body within the reception bore of the adapter body for cooperating with the compression nut.

12. A cold spray nozzle assembly as recited in claim 9, wherein the converging passage of the adapter body includes a throat section of constant diameter extending within the frusto-conical seat.

13. A cold spray nozzle assembly comprising:
a) a nozzle body formed from a polymeric material and having a diverging passage extending along an axis; and
b) an adapter body formed from a metallic material and having a converging passage extending along an axis.

14. A cold spray nozzle assembly as recited in claim 13, wherein the nozzle body has a proximal engagement portion and a distally extending barrel portion, and wherein the diverging passage extends from the proximal engagement portion toward a distal exit end of the barrel portion.

15. A cold spray nozzle assembly as recited in claim 14, wherein the adapter body has a proximal connector portion for mating with a fitting and a distal engagement portion for mating with the proximal engagement portion of the nozzle body, and wherein the converging passage extends from the proximal connector portion to the distal engagement portion for communicating with the diverging passage of the nozzle body.

16. A cold spray nozzle assembly as recited in claim 15, wherein the distal engagement portion of the adapter body has a reception bore formed therein for receiving the proximal engagement portion of the nozzle body.

17. A cold spray nozzle assembly as recited in claim 16, wherein a frusto-conical seat is formed at a proximal end of the reception bore for mating with a complementary shaped recess formed in a proximal end of the nozzle body.

18. A cold spray nozzle assembly as recited in claim 16, wherein an exterior surface of the distal engagement portion of the adapter body is threaded for receiving a compression nut configured to temporarily secure the adapter body and nozzle body to one another.

19. A cold spray nozzle assembly as recited in claim 18, further comprising a compression sleeve dimensioned for placement upon the nozzle body adjacent the proximal engagement portion of the nozzle body within the reception bore of the adapter body for cooperating with the compression nut.

20. A cold spray nozzle assembly as recited in claim 17, wherein the converging passage of the adapter body includes a throat section of constant diameter extending within the frusto-conical seat.
